(19) United States
(12) Patent Application Publication
(10) Pub. No.: US 2013/0135154 A1
(43) Pub. Date: May 30, 2013

(54) PORTABLE WIRELESS DEVICE

(71) Applicant: Shingo Sumi, Miyagi (JP)

(72) Inventor: Shingo Sumi, Miyagi (JP)

(73) Assignee: PANASONIC CORPORATION, Osaka (JP)

(21) Appl. No.: 13/814,440

(22) PCT Filed: Aug. 1, 2011
(86) PCT No.: PCT/JP2011/004364

§ 371 Date: Feb. 5, 2013

(30) Foreign Application Priority Data
Aug. 9, 2010 (JP) 2010-178827

(51) Int. Cl. H01Q 1/38

(52) U.S. Cl. CPC H01Q 1/38
USPC 343/700 MS

(57) ABSTRACT

A portable wireless device includes: first and second circuit boards each including a ground pattern; first and second power feeding portions provided on the first and second circuit boards, respectively; and first and second antenna elements connected to the first and second power feeding portions, respectively. The first circuit board is arranged substantially parallel to the second circuit board. A first connection portion provided on the first circuit board is electrically connected to a second connection portion provided on the second circuit board via a connection line. A slit is formed by cutting any one of: a part of the ground pattern of the first circuit board at a position between the first power feeding portion and the first connection portion; and a part of the ground pattern of the second circuit board at a position between the second power feeding portion and the second connection portion.

### TECHNICAL FIELD

The present invention relates to a portable wireless device such as a mobile phone, and in particular, to a portable wireless device which includes a plurality of antenna elements to perform diversity communication.

### BACKGROUND ART

A portable wireless device including a plurality of antenna elements to perform diversity communication is known, for example, in Patent Documents 1 and 2. The portable wireless device described in Patent Document I feeds power to two antenna elements from different circuit boards, respectively, and includes a high-impedance connection means which cuts the circuit boards in high frequency, whereby reducing deterioration of antenna performance due to an electromagnetic coupling between the two antenna elements. The electromagnetic coupling between the two antenna elements increases as the distance between the antennae decreases.

In a mobile phone described in Patent Document 2, a first antenna element which operates in a first frequency band and a second antenna element which operates in a second frequency band are arranged close to each other. The mobile phone further includes resonant circuits provided on power feeding paths of the first antenna element and the second antenna element, respectively. One resonant circuit provided on one antenna element cuts signals of the frequency for the other antenna element, and vice versa. Accordingly, the mobile phone reduces deterioration of antenna performance due to an electromagnetic coupling between the two antenna elements. Further, a third antenna element which operates in the first frequency band is provided far from the first antenna element. Accordingly, the mobile phone also reduces deterioration of antenna performance due to an electromagnetic coupling between the two antenna elements.

### RELATED ART DOCUMENTS

### Patent Documents

Patent Document 1: JP-A-11-163756

Patent Document 2: JP-A-2009-164772

### SUMMARY OF THE INVENTION

### Problem to be Solved by the Invention

In the portable wireless device described in Patent Document 1 and the mobile phone described in Patent Document 2, the high-impedance connection means or the resonant circuits are provided for reducing deterioration of antenna performance due to an electromagnetic coupling between the adjacent two antenna elements, but lead to the problems of avoiding reduction of size of a device body and increasing cost.

Further, in the mobile phone described in Patent Document 2, the first antenna element and the third antenna element are provided distant from each other for reducing the deterioration of antenna performance due to the electromagnetic coupling between the antenna elements. However, by providing the antenna elements distant from each other, since the matching circuit units and the resonant circuit units connected to the respective antenna elements are wired on a circuit board, the size of the circuit board is increased, which avoids reduction of size of the device body.

The present invention was made in view of the above-described circumstances, and an object thereof is to provide a portable wireless device capable of reducing size of a device body and cost, while suppressing deterioration of antenna performance due to an electromagnetic coupling caused by closely arranging two antenna elements.

### Means for Solving the Problem

The present invention provides a portable wireless device including: a first circuit board including a ground pattern; a first power feeding portion provided on the first circuit board; a first antenna element connected to the first power feeding portion; a second circuit board including a ground pattern; a second power feeding portion provided on the second circuit board; and a second antenna element connected to the second power feeding portion, wherein the first circuit board is arranged substantially parallel to the second circuit board, wherein a first connection portion provided on the first circuit board is electrically connected to a second connection portion provided on the second circuit board via a connection line, and wherein a slit is formed by cutting any one of: a part of the ground pattern of the first circuit board at a position between the first power feeding portion and the first connection portion; and a part of the ground pattern of the second circuit board at a position between the second power feeding portion and the second connection portion.

With this configuration, for example, in a case in which the slit is formed in a part of the ground pattern of the first circuit board at a position between the first power feeding portion and the first connection portion, the slit creates an inductor corresponding to the path length of the slit. The inductor and inter-board capacity created between the ground pattern of the first circuit board and the ground pattern of the second circuit board provide an effect of arranging a high-frequency filter (that is, a low pass filter) between the ground patterns. By the filter effect, it is possible to secure isolation between the ground pattern of the first circuit board and the ground pattern of the second circuit board, and suppress the deterioration of antenna performance due to the electromagnetic coupling between the first antenna element and a second antenna element. Similarly, also in a case in which the slit is formed in a part of the ground pattern of the second circuit board at a position between the second power feeding portion and the second connection portion, it is possible to secure isolation between the ground patterns of the two circuit boards, and suppress the deterioration of antenna performance due to the electromagnetic coupling between the two antenna elements. Further, it is unnecessary to provide means for suppressing the deterioration of antenna performance due to the electromagnetic coupling between the antenna elements, that is, the matching circuit units and the resonant circuit units, and also unnecessary to wire the matching circuit units and the resonant circuits on the circuit board. Consequently, reduction of size of a device body is not avoided, and cost increase can be kept to the minimum.

In the portable wireless device, two slits are formed by cutting both of: a part of the ground pattern of the first circuit board at a position between the first power feeding portion and the first connection portion; and a part of the ground pattern of the second circuit board at a position between the second power feeding portion and the second connection portion.

With this configuration, it is possible to secure the isolation between the ground patterns for both of the first circuit board and the second circuit board. Consequently, it is possible to further suppress the deterioration of antenna performance of the two antenna elements due to the electromagnet coupling.

In the portable wireless device, the slit of the first circuit board is positioned so as not to overlap with the slit of the second circuit board in plan view.

With this configuration, by providing the slit of the first circuit board so as not to overlap with the slit of the second circuit board, the electrostatic capacity between the circuit boards can be kept small, and a current distribution on the ground pattern of the first circuit board of the first antenna element can be made different from that on the ground pattern of the second circuit board of the second antenna element, whereby high isolation improvement effect can be obtained. Consequently, it is possible to further suppress the deterioration of antenna performance of the two antenna elements due to the electromagnet coupling.

In the portable wireless, a reactance element is provided at an open end of the slit.

With this configuration, by providing the reactance element at the open end of the slit, the designer can easily adjust characteristics of the high-frequency filter containing the inductor formed by the slit. Further, it is possible to improve cutoff characteristics of the high-frequency filter containing the inductor formed by the slit.

In the portable wireless, a capacitor is used as the reactance element, and a capacitance value of the capacitor is set to resonate with an inductance value of the slit at an antenna operating frequency.

With this configuration, the designer can easily adjust characteristics of the high-frequency filter containing the capacitor and the inductor formed by the slit. Further, it is possible to improve cutoff characteristics of the high-frequency filter containing the capacitor and the inductor formed by the slit.

### Advantages of the Invention

According to the present invention, it is possible to reduce size of a device body and cost, while suppressing deterioration of antenna performance due to an electromagnetic coupling caused by closely arranging two antenna elements.

### BRIEF DESCRIPTION OF THE DRAWINGS

FIG. 1 is a perspective view showing a schematic configuration of a portable wireless device according to an Embodiment 1 of the present invention.

FIG. 2 is a diagram showing an equivalent circuit configuration of the portable wireless device shown in FIG. 1.

FIG. 3 is a diagram showing an equivalent circuit configuration in a case in which the slit is not provided in the portable wireless device shown in FIG. 1.

FIG. 4 is a graph showing measurement results of isolation between antenna elements of the portable wireless device shown in FIG. 1.

FIG. 5 is a perspective view showing a schematic configuration of a portable wireless device according to an Embodiment 2 of the present invention.

FIG. 6 is a plan view showing a schematic configuration of the portable wireless device shown in FIG. 5.

FIG. 7 is a perspective view showing a schematic configuration of a portable wireless device according to an Embodiment 3 of the present invention.

FIG. 8 is a diagram showing an equivalent circuit configuration of the portable wireless device shown in FIG. 7.

FIGS. 9(a) and 9(b) are diagrams showing a schematic configuration of a slider mobile phone according to an Example 1.

FIGS. 10(a) and 10(b) are vertical cross-sectional views of the slider mobile phone shown in FIG. 9.

FIGS. 11(a) to 11(c) are diagrams showing a schematic configuration of a bar mobile phone according to an Example 2.

### MODE FOR CARRYING OUT THE INVENTION

Hereinafter, embodiments of the invention will be described with reference to the drawings.

### Embodiment 1

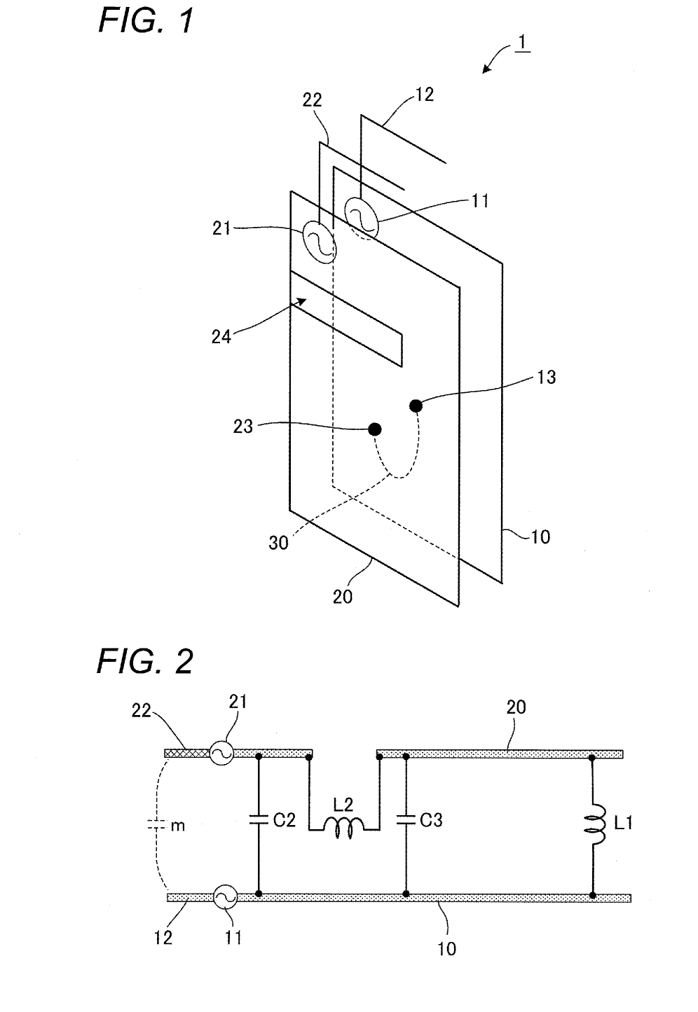

FIG. 1 is a perspective view showing a schematic configuration of a portable wireless device according to an Embodiment 1 of the present invention. In FIG. 1, a portable wireless device 1 of this embodiment includes: a first circuit board 10 including a ground pattern; a first power feeding portion 11 provided on the first circuit board 10; a first antenna element 12 connected to the first power feeding portion 11; a second circuit board 20 including a ground pattern; a second power feeding portion 21 provided on the second circuit board 20; a second antenna element 22 connected to the second power feeding portion 21; and a connection cable (connection line) 30 electrically connecting a first connection portion 13 provided on the first circuit board 10 with a second connection portion 23 provided on the second circuit board 20.

The first circuit board 10 is arranged substantially parallel to the second circuit board 20. The first power feeding portion 11 is arranged at a left corner portion of the first circuit board 10. The second power feeding portion 21 is arranged at a left corner portion of the second circuit board 20. A slit 24 is formed in a part of the ground pattern of the second circuit board 20 at a position between the second power feeding portion 21 and the second connection portion 23. The slit 24 is formed by cutting the ground pattern. The slit 24 is opened on a left side of the second circuit board 20 in FIG. 1. The slit 24 is formed by cutting the ground pattern of the second circuit board 20, but may be formed by cutting the second circuit board 20 itself.

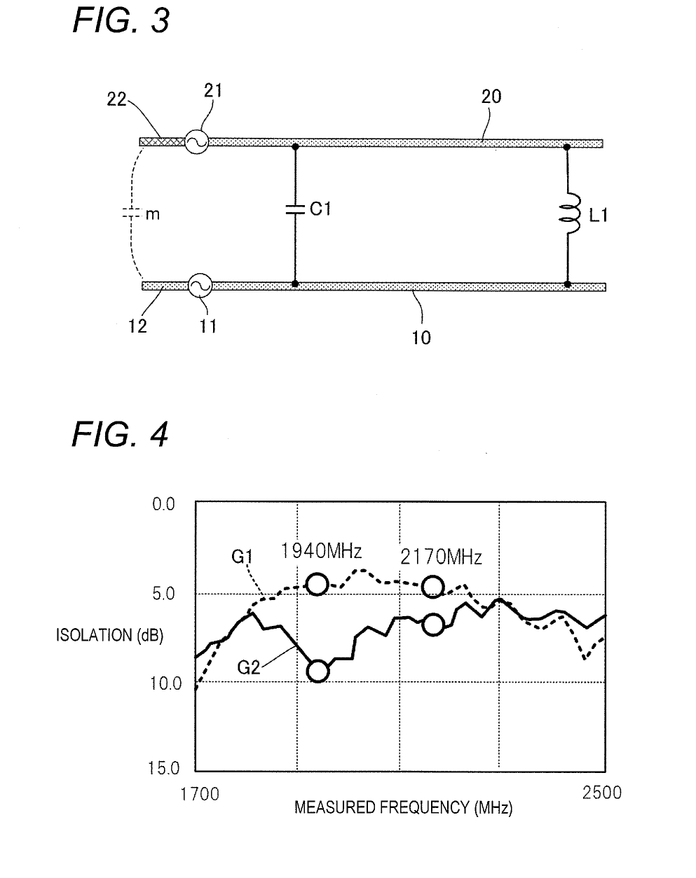

FIG. 2 is a diagram showing an equivalent circuit configuration of the portable wireless device 1 shown in FIG. 1. FIG. 3 is a diagram showing an equivalent circuit configuration in a case in which the slit 24 is not provided in FIG. 1. As shown in FIG. 3, in the case in which the slit 24 is not formed, the first circuit board 10 and the second circuit board 20 are connected by a capacitor C1 created between the ground patterns of the circuit boards 10, 20, and an inductor L1 of the connection cable 23. In contrast, in the case in which the slit 24 is formed in the second circuit board 20, as shown in FIG. 2, the capacitor C1 created between the ground pattern of the first circuit board 10 and the ground pattern of the second circuit board 20 is divided into capacitors C2, C3, and an inductor L2 is created corresponding to a path length of the slit 24. In this case, since the capacitor C2 has sufficient small capacitance, the remaining capacitor C3 and the inductor L2 provide an effect of arranging a high-frequency filter (that is, a low pass filter) between the ground pattern of the first circuit board 10 and the ground pattern of the second circuit board 20. By the filter effect, the isolation between the ground pattern of the first circuit board 10 and the ground pattern of the second circuit board 20 is improved, and it is possible to suppress the deterioration of antenna performance due to the electromagnetic coupling between the first antenna element 12 and a second antenna element 22.

Further, it is unnecessary to provide means for suppressing the deterioration of antenna performance due to the electromagnetic coupling between the first antenna element 12 and the second antenna element 22, that is, the matching circuit units and the resonant circuit units used in the related art, and also unnecessary to wire the matching circuit units and the resonant circuits on the circuit board. Consequently, reduction of size of a device body is not avoided, and cost increase can be kept to the minimum.

FIG. 4 is a graph showing measurement results of isolation between antenna elements of the portable wireless device 1 shown in FIG. 1, in which the measured frequency (MHz) is set on the horizontal axis, and the isolation (dB) is set on the vertical axis. The condition of the isolation between the antenna elements improves as the value increases. The graph G1 indicated by dotted line shows the measurement result of the isolation between the antenna elements of the portable wireless device of the related art in which the slit is not formed in the circuit board. The graph G2 indicated by solid line shows the measurement result of the isolation between the antenna elements of the portable wireless device 1 of the present embodiment in which the slit is formed in the circuit board. For example, the isolation at 1940 MHz is about 4.9 dB in the portable wireless device of the related art, whereas being about 9.9 dB in the portable wireless device 1 of the present embodiment. That is, the isolation of the portable wireless device 1 of the present embodiment is about 5 dB higher. The isolation at 2170 MHz is about 5 dB in the portable wireless device of the related art, whereas being about 6.5 dB in the portable wireless device 1 of the present embodiment. That is, the isolation of the portable wireless device 1 of the present embodiment is about 1.5 dB higher. Accordingly, by providing the slit in the circuit board, the isolation between the ground patterns of the circuit boards is found to be improved.

According to the portable wireless device 1 of the present embodiment, the slit 24 is formed in a part of the ground pattern of the second circuit board 20 at a position between the second power feeding portion 21 and the second connection portion 23. Consequently, the inductor L2 corresponding to the path length of the slit 24 and the capacitor C3 created between the ground pattern of the first circuit board 10 and the ground pattern of the second circuit board 20 can provide an effect of arranging a high-frequency filter (that is, a low pass filter) between the ground patterns By the filter effect, it is possible to secure the isolation between the ground pattern of the first circuit board 10 and the ground pattern of the second circuit board 20, and also possible to suppress the deterioration of antenna performance due to the electromagnetic coupling between the first antenna element 12 and a second antenna element 22. Further, it is unnecessary to provide means for suppressing the deterioration of antenna performance due to the electromagnetic coupling between the antenna elements 12, 22, that is, the matching circuit units and the resonant circuit units, and also unnecessary to wire the matching circuit units and the resonant circuits on the circuit board. Consequently, reduction of size of a device body is not avoided, and cost increase can be kept to the minimum.

### Embodiment 2

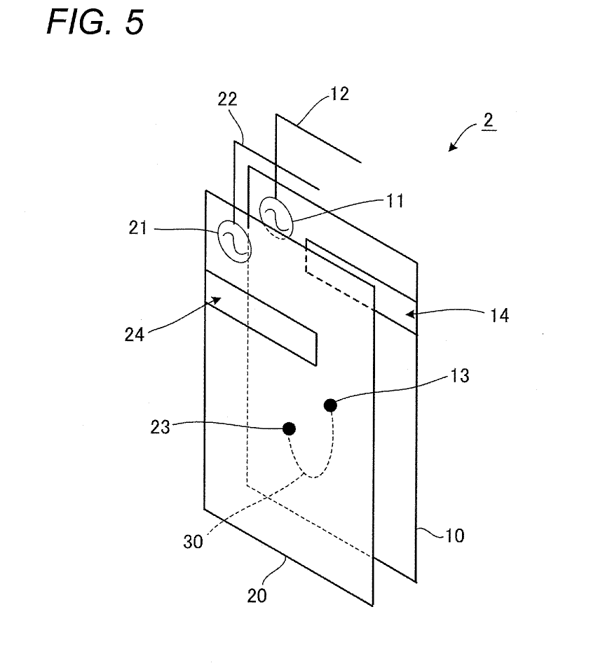

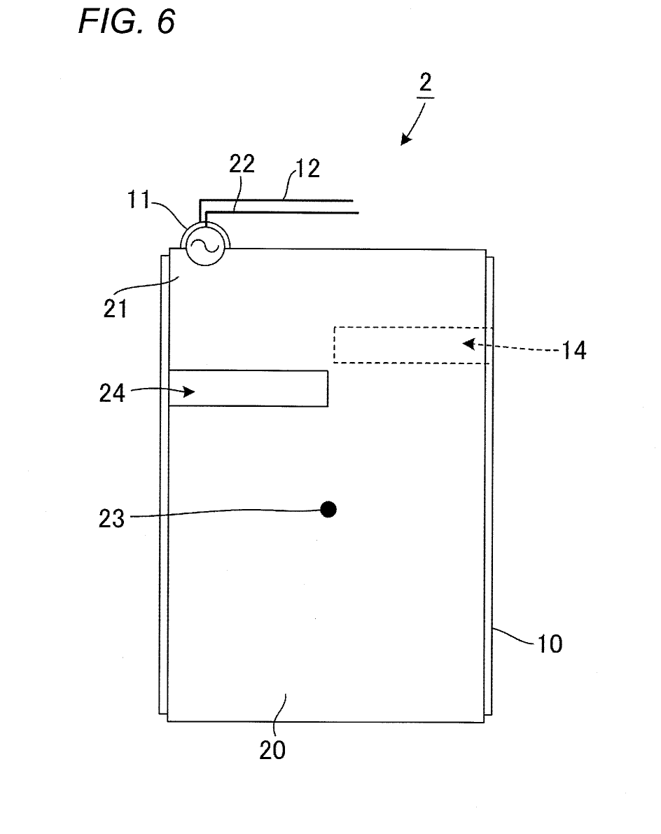

FIG. 5 is a perspective view showing a schematic configuration of a portable wireless device according to an Embodiment 2 of the present invention. FIG. 6 is a plan view showing a schematic configuration of the portable wireless device shown in FIG. 5. In FIGS. 5 and 6, the same reference numerals are assigned to the portions common to those shown in FIG. 1.

As shown in FIGS. 5 and 6, in a portable wireless device 2 of the present embodiment, a slit 14 similar to the slit 24 of the second circuit board 20 is also formed in the first circuit board 10. That is, in the portable wireless device 2 of the present embodiment, the slit 14 is formed also in a part of the ground pattern of the first circuit board 10 at a position between the first power feeding portion 11 and the first connection portion 13. The slit 14 is formed by cutting the ground pattern, similar to the slit 24. The slit 14 is opened on a right side of the first circuit board 10 in FIG. 5. The slit 14 is formed by cutting the ground pattern of the first circuit board 10, but may be formed by cutting the first circuit board 10 itself.

The slit 14 of the first circuit board 10 is positioned so as not to overlap with the slit 24 of the second circuit board 20 in plan view. By providing the two slits 14, 24 at the position so as not to overlap with each other in plan view, the capacitance value of the capacitor C3 created between the ground pattern of the first circuit board 10 and the ground pattern of the second circuit board 20 can be kept small, and current distributions on the grounds of the first antenna element 12 and the second antenna element 22 can be made different from each other, whereby high isolation improvement effect can be obtained as compared with the portable wireless device 1 of the Embodiment 1. By forming the slit 14 in the first circuit board 10, an inductor corresponding to a path length of the slit 14 is created, similar to the case in which the slit 24 is formed in the second circuit board 20, a path length of the slit 14.

According to the portable wireless device 2 of the present embodiment, the slit 24 is formed in a part of the ground pattern of the second circuit board 20 at a position between the second power feeding portion 21 and the second connection portion 23, and the slit 14 is formed in a part of the ground pattern of the first circuit board 10 at a position between the first power feeding portion 11 and the first connection portion 13. Consequently, it is possible to secure the isolation between the ground pattern of the first circuit board 10 and the ground pattern of the second circuit board 20, and also possible to suppress the deterioration of antenna performance due to the electromagnetic coupling between the first antenna element 12 and the second antenna element 22. In particular, the slit 14 of the first circuit board 10 is arranged at a position so as not to overlap with the slid 24 of the second circuit board 20 in plan view. Consequently, the capacitance value of the capacitor C3 created between the ground pattern of the first circuit board 10 and the ground pattern of the second circuit board 20 can be kept small, and the current distributions on the grounds of the first antenna element 12 and the second antenna element 22 can be made different from each other, whereby high isolation improvement effect can be obtained as compared with the portable wireless device 1 of the Embodiment 1.

### Embodiment 3

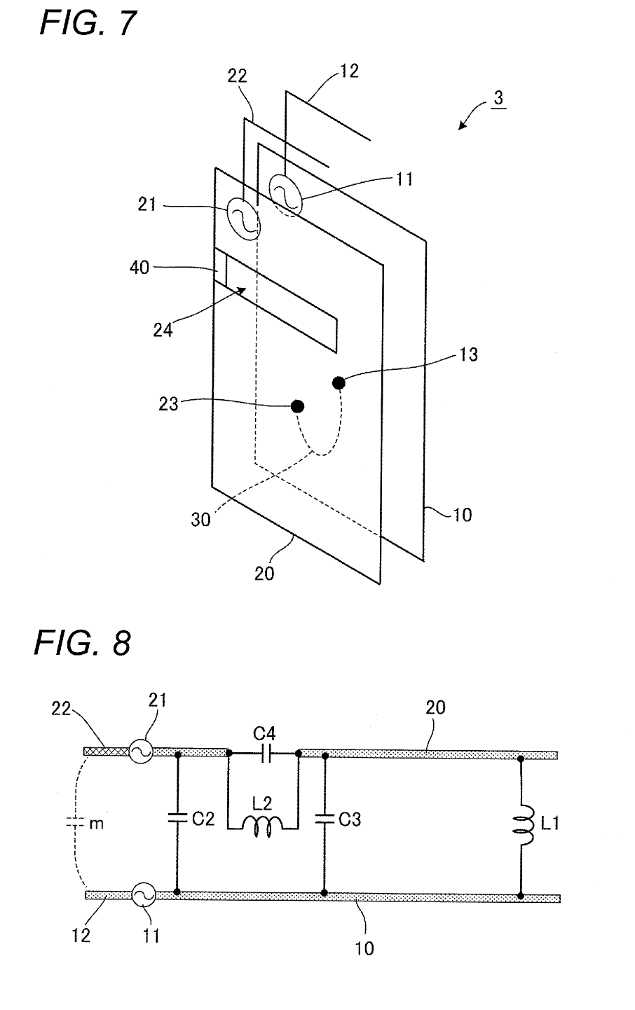

FIG. 7 is a perspective view showing a schematic configuration of a portable wireless device according to an Embodiment 3 of the present invention. In FIG. 7, the same reference numerals are assigned to the portions common to those shown in FIG. 1.

As shown in FIG. 7, a portable wireless device 3 of the present embodiment includes the slit in the second circuit board 20, similar to the Embodiment 1 as described above, but is different from the Embodiment 1 in that a capacitor 40 is provided as a reactance element at the open end of the slit 24. FIG. 8 is a diagram showing an equivalent circuit configuration of the portable wireless device 3 shown in FIG. 7.

A capacitance value C4 of the capacitor 40 is set to resonate with an inductance value L2 of the slit at an operating frequency of the second antenna element 22. By providing the capacitor 40 at the open end the slit 24, a parallel resonant circuit is formed by the inductor having the inductance value L2 by the slit 24 and the capacitor 40 having the capacitance value C4, and it is possible to improve cutoff characteristics of the high-frequency filter between the ground pattern of the first circuit board 10 and the ground pattern of the second circuit board 20, whereby the isolation is further improved. Further, the designer can easily adjust characteristics of the high-frequency filter formed by the slit.

According to the portable wireless device 3 of the present embodiment, the slit 24 is formed in a part of the ground pattern of the second circuit board 20 at a position between the second power feeding portion 21 and the second connection portion 23, and the capacitor 40 is provided as the reactance element at the open end of the slit 24. Consequently, it is possible to secure the isolation between the ground pattern of the first circuit board 10 and the ground pattern of the second circuit board 20, and also possible to suppress the deterioration of antenna performance due to the electromagnetic coupling between the first antenna element 12 and the second antenna element 22. Further, the designer can easily adjust characteristics of the high-frequency filter formed by the slit.

Next, the examples of the present invention will be described.

### Example 1

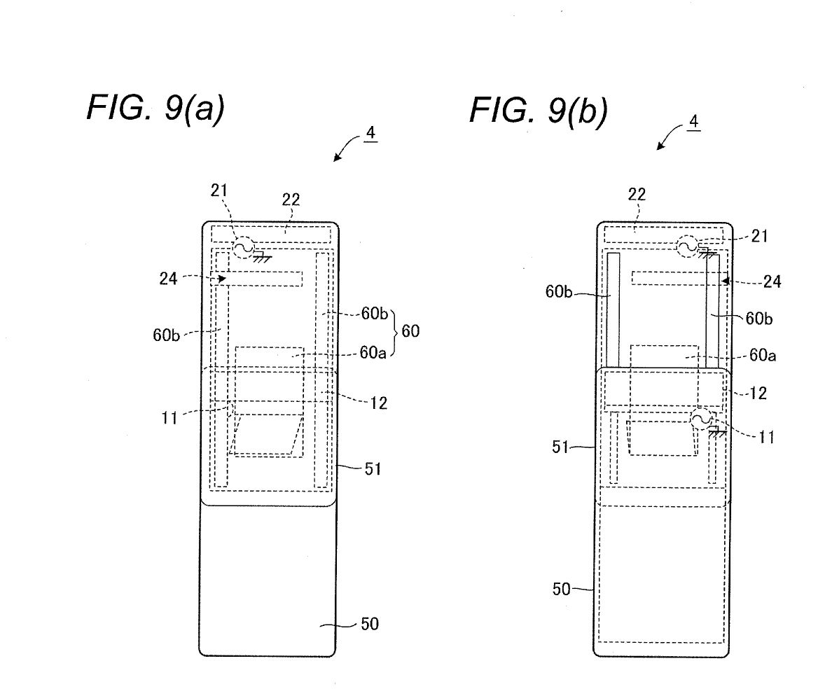

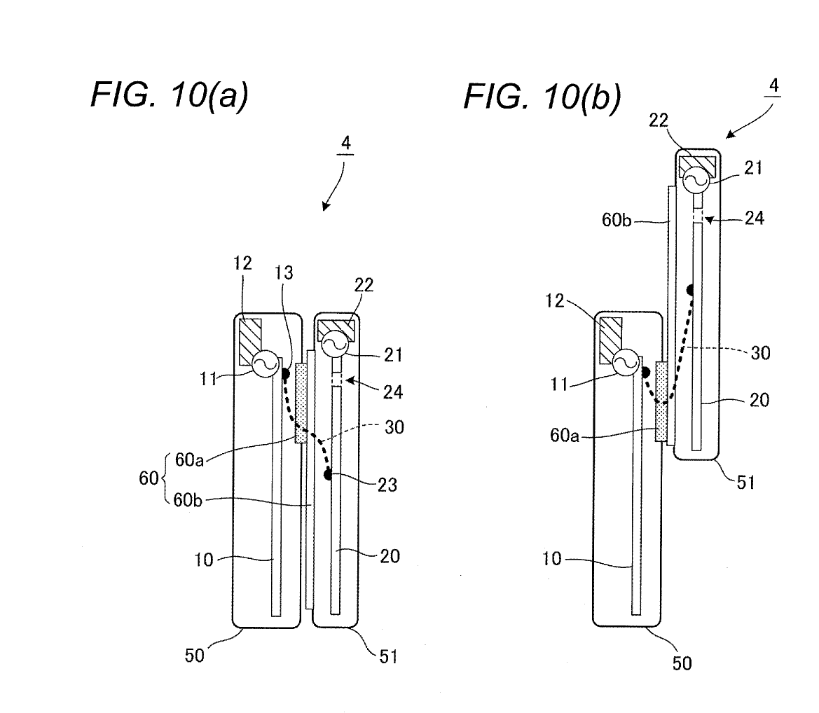

FIG. 9 is a diagram showing a schematic configuration of a slider mobile phone according to an Example 1, in which FIG. 9(a) is a plan view and FIG. 9(b) is a rear view. FIG. 10 is a vertical cross-sectional view of the slider mobile phone shown in FIG. 9, in which FIG. 9(a) is a cross-sectional view of a closed state and FIG. 9(b) is a cross-sectional view of a slid state. In FIGS. 9(a) and 9(b) and FIGS. 10(a) and (b), the same reference numerals are assigned to the portions common to those shown in FIG. 1.

A slider mobile phone 4 of the Example 1 includes: a lower casing 50; an upper casing 51; and a slide mechanism 60 which slides the lower casing 50 and the upper casing 51. The slide mechanism 60 includes: a movable plate 60a fixed to the lower casing 50; and a fixed plate 60b fixed to the upper casing 51. The slide mechanism 60 allows the upper casing 51 to slide vertically relative to the lower casing 50.

The lower casing 50 includes therein: the first circuit board 10 including the ground pattern; the first power feeding portion 11 provided on the first circuit board 10; and the first antenna element 12 connected to the first power feeding portion 11. The upper casing 51 includes therein: the second circuit board 20 including the ground pattern; the second power feeding portion 21 provided on the second circuit board 20; and the second antenna element 22 connected to the second power feeding portion 21. The first connection portion 13 provided on the first circuit board 10 in the lower casing 50 is connected to the second connection portion 23 provided on the second circuit board 20 in the upper casing 51 via the connection cable 30. In the second circuit board 20, the slit 24 is formed.

In the slider mobile phone 4, since the first circuit board 10 is positioned parallel to the second circuit board 20 in the closed state, it is possible to secure the isolation between the ground pattern of the first circuit board 10 and the ground pattern of the second circuit board 20 in the closed state, and possible to suppress the deterioration of antenna performance due to the electromagnetic coupling between the first antenna element 12 and the second antenna element 22.

### Example 2

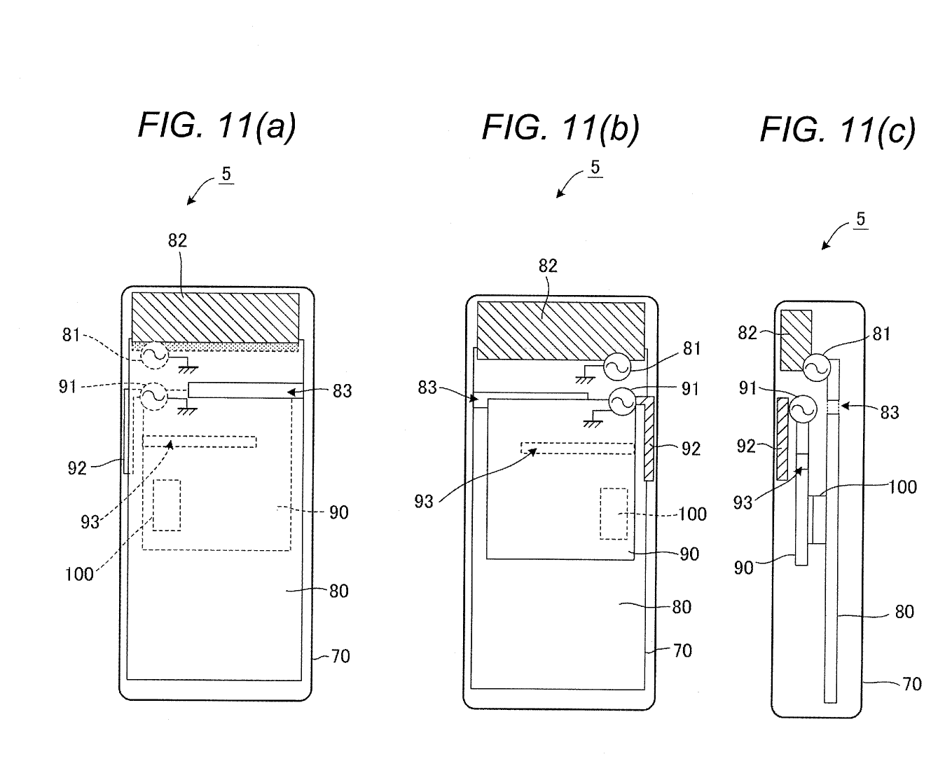

FIG. 11 is a diagram showing a schematic configuration of a bar mobile phone according to an Example 2, in which FIG. 11(a) is a front view, FIG. 11(b) is a rear view, and FIG. 11(c) is a vertical cross-sectional view. In FIGS. 11(a) to 11(c), the same reference numerals are assigned to the portions common to those shown in FIG. 1.

A bar mobile phone 5 of the Example 2 includes a single casing 70. The casing 70 includes therein: a first circuit board 80 including a ground pattern; a first power feeding portion 81 provided on the first circuit board 80; a first antenna element 82 connected to the first power feeding portion 81; a second circuit board 90 which is connected to the first circuit board 80 via an inter-board connector (a connecter between the boards) 100 and which includes a ground pattern; a second power feeding portion 91 provided on the a second circuit board 90; the a second antenna element 92 connected to the second power feeding portion 91.

The first circuit board 80 is arranged parallel to the second circuit board 90 by the inter-board connector 100. The second circuit board 90 serves as an auxiliary board of the first circuit board 80, and is formed smaller than the first circuit board 80 and arranged slightly upper than the center of the second circuit board 90. A slit 83 is formed in the ground pattern of the first circuit board 80, and a slit 93 is also formed in the ground pattern of the second circuit board 90. In this case, the formation positions of the slits 83, 93, including the attaching positions of the first circuit board 80 and the second circuit board 90, are determined such that the slit 83 does not overlap with the slit 93.

The slit 83 is formed in a part of the ground pattern of the first circuit board 80 at a position between the first power feeding portion 81 and the inter-board connector 100, and the slit 93 is formed in a part of the ground pattern of the second circuit board 90 at a position between the second power feeding portion 91 and the inter-board connector 100. Consequently, it is possible to secure the isolation between the ground pattern of the first circuit board 80 and the ground pattern of the second circuit board 90, and also possible to suppress the deterioration of antenna performance due to the electromagnetic coupling between the first antenna element 82 and the second antenna element 92. In particular, the slit 83 of the first circuit board 80 is arranged at a position so as not to overlap with the slit 93 of the second circuit board 90 in plan view. Consequently, a capacitance value of a capacitor created between the ground pattern of the first circuit board 80 and the ground pattern of the second circuit board 90 can be kept small, and the current distributions on the grounds of the first antenna element 82 and the second antenna element 92 can be made different from each other, whereby high isolation improvement effect can be obtained as compared with the slider mobile phone 4 of the Example 1.

The present invention is not limited to the slider mobile phone 4 and the bar mobile phone 5 as described above, and may of course be applied to a flip mobile phone.

Although the present invention is described in detail with reference to specific embodiments, it is apparent to a person having ordinary skill in the art that various changes or modifications may be made without departing from the sprit and scope of the invention.,

The application is based on the Japanese patent application (Application No. 2010-178827) filed on Aug. 9, 2010, the entire contents of which are incorporated herein by reference.

### INDUSTRIAL APPLICABILITY

The present invention provides advantages in which the size of the device body and cost can be reduced while the deterioration of antenna performance due to the electromagnetic coupling caused by closely arranging two antenna elements can be suppressed, and is applicable to a portable wireless device such as a slider mobile phone, a bar mobile phone, a flip mobile phone, etc.

### DESCRIPTION OF REFERENCE SKINS

1, 2, 3: Portable Wireless Device

4: Slider Mobile Phone

5: Bar Mobile Phone

10, 80: First Circuit Board

11, 81: First Power Feeding Portion

12, 82: First Antenna Element

13: First Connection Portion

14, 24, 83, 93: Slit

20, 90: Second Circuit Board

21, 91: Second Power Feeding Portion

22, 92: Second Antenna Element

23: Second Connection Portion

30: Connection Cable

40: Capacitor

50: Lower Casing

51: Upper Casing

60: Slide Mechanism

60a: Movable Plate

60b: Fixed Plate

70: Casing

100: Inter-Board Connector

1. A portable wireless device comprising:
a first circuit board comprising a ground pattern;
a first power feeding portion provided on the first circuit board;
a first antenna element connected to the first power feeding portion;
a second circuit board comprising a ground pattern;
a second power feeding portion provided on the second circuit board; and
a second antenna element connected to the second power feeding portion,
wherein the first circuit board is arranged substantially parallel to the second circuit board,
wherein a first connection portion provided on the first circuit board is electrically connected to a second connection portion provided on the second circuit board via a connection line, and
wherein a slit is formed by cutting any one of: a part of the ground pattern of the first circuit board at a position between the first power feeding portion and the first connection portion; and a part of the ground pattern of the second circuit board at a position between the second power feeding portion and the second connection portion.

2. The portable wireless device according to claim 1,
wherein two slits are formed by cutting both of: a part of the ground pattern of the first circuit board at a position between the first power feeding portion and the first connection portion; and a part of the ground pattern of the second circuit board at a position between the second power feeding portion and the second connection portion.

3. The portable wireless device according to claim 2,
wherein the slit of the first circuit board is positioned so as not to overlap with the slit of the second circuit board in plan view.

4. The portable wireless device according to claim 1,
a reactance element is provided at an open end of the slit.

5. The portable wireless device according to claim 4,
wherein a capacitor is used as the reactance element, and
wherein a capacitance value of the capacitor is set to resonate with an inductance value of the slit at an antenna operating frequency.
